(19) United States
(12) Patent Application Publication
(10) Pub. No.: US 2006/0160694 A1
(43) Pub. Date: Jul. 20, 2006

(54) Supported group-4, group-5, and group-6 metal clusters, preparation of the material and use of the material as a catalyst

(75) Inventors: Sailendra Nemana, Carmichael, CA (US); Bruce C. Gates, El Macero, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California Office of Technology Transfer, Oakland, CA (US)

(21) Appl. No.: 11/292,787

(22) Filed: Dec. 1, 2005

Related U.S. Application Data
(60) Provisional application No. 60/632,581, filed on Dec. 1, 2004.

(51) Int. Cl. B01J 29/04; B01J 27/187; B01J 23/00; B01J 29/87; B01J 27/14; C07F 9/00

(52) U.S. Cl. 502/60; 502/208; 502/300; 502/305; 502/308; 502/311; 556/43

(57) ABSTRACT

A method of forming supported group 4, and/or 5, and/or 6 metal clusters, which may be used as a catalyst for alkane reactions. The method includes combining a solid support and a precursor compound of group 4, 5, or 6 metals, or precursor compounds of group 4, and/or 5, and/or 6 metals, or a precursor compound of a combination of group 4, 5, and/or 6 metals, and combinations thereof; and optionally treating the combination to form the supported group 4, and/or 5, and/or 6 clusters. The material formed by the combination of the precursor or precursors with a solid support following an optional treatment can be used as a catalyst for disproportionation of alkanes and/or conversion of one or more alkanes with another alkane or other alkanes by contacting the material with the alkanes.

### CROSS-REFERENCES TO RELATED APPLICATIONS

This application claims priority to U.S. Provisional Patent Application No. 60/632,581, filed Dec. 1, 2004, the disclosure of which is hereby incorporated by reference herein in its entirety for all purposes.

### STATEMENT AS TO RIGHTS TO INVENTIONS MADE UNDER FEDERALLY SPONSORED RESEARCH AND DEVELOPMENT

This invention was made with Government Support under Grant (or Contract) No. CTS0300982, awarded by the National Science Foundation. The Government has certain rights in this invention.

### BACKGROUND OF THE INVENTION

The present invention relates in general to metal clusters (defined herein as groups of two or more metal atoms linked to each other by metal-metal bonds and/or by bridging atoms or groups of atoms; examples include but are not restricted to lines or triangles with three linked metal atoms; tetrahedra with four linked metal atoms; raft- or sheet-like structures with two-dimensional metal frameworks, and structures with three-dimensional metal frameworks) supported on solids and, in particular, to tantalum clusters supported on metal oxides, which are materials that are capable of being used to catalyze the disproportionation reaction of alkanes (disproportionation is defined herein as the reaction of a starting alkane to produce alkanes that have molecular weights that are higher and lower than that of the starting alkane) and conversions of alkanes with each other to give alkane products with molecular weights different from those of the starting alkanes. It is known that selective and economical conversion of alkanes is difficult. There is a potential benefit from improved catalysts and catalytic processes for the selective conversion of alkanes, especially methane. A new class of chemical processes could emerge from economical new routes to methane conversion. In particular, the economic conversion of methane to higher molecular-weight alkanes would represent a way to enhance their economic value.

### BRIEF SUMMARY OF THE INVENTION

The embodiments of the present invention are directed towards the composition and structure of catalytic material, namely, group-4, and/or group-5 and/or group-6 metal clusters (where the groups in the Periodic Table of the Elements are as defined as in the CRC Handbook of Chemistry and Physics, 73rd Edition, CRC Press, Boca Raton, 1992-1993, as shown on the inside front cover), exemplified by tantalum clusters, supported on solids such as metal oxides, their method of preparation, and the method of converting alkanes by contacting alkanes with the catalytic material. The materials incorporating metal clusters are active for the catalytic disproportionation of alkanes and related reactions, including the reaction of two different alkanes with each other to form other alkanes with molecular weights different from those of the starting alkanes. Others' work in this area has been related to the preparation of mononuclear (single-metal-atom) compounds (also known as complexes), including coordinatively unsaturated complexes, of early transition metals (including group-4, group-5, and group-6 metals, specifically including tantalum) bound to metal oxides which are active for the catalytic disproportionation (sometimes referred to as metathesis) of alkanes and the reaction of two different alkanes with each other to form other alkanes with molecular weights different from those of the starting alkanes. The embodiments of the present invention stabilize early transition metals (exemplified by tantalum) in the form of supported clusters. The stabilization of early transition metals (exemplified by those of groups 4, 5, and 6 and more specifically by tantalum) in the form of supported clusters in accordance with the embodiments of the present invention has not been recognized by others, nor have such materials been reported by others prior to the work of the present inventors. At best, some of the past work refers to isolated mononuclear (i.e., single metal-atom) species, which are not metal clusters.

Another aspect of the present invention is directed towards a method for controlling the average number of metal atoms comprising the supported clusters, which in addition to the formation of such clusters is also a significant improvement over the current state of the art. Yet another aspect of the present invention relates to the economic method of preparation of the catalytic material, which is also a significant improvement over the current state of the art.

In one embodiment, the preparation of metal oxide-supported tantalum clusters involves the following steps:

1. A metal oxide is used as a support, and it may be modified by treatments to cause a degree of dehydroxylation or hydroxylation. In one embodiment, the dehydroxylation is conducted at approximately 500° C. under vacuum conditions for a duration of time. In one embodiment, the duration is about 16 hours.

2. A precursor compound (e.g., pentabenzyltantalum) is synthesized by the method outlined by Groysman et al. (e.g., see Groysman et al., Organometallics, 22:3793 (2003))

3. The precursor (e.g., pentabenzyltantalum) and a partially dehydroxylated or hydroxylated metal oxide support are slurried in an organic solvent (e.g., hexane). The solvent (e.g., hexane) is removed by evacuation after stirring of the mixture overnight with the exclusion of air and moisture.

The process involving these steps enables the formation of metal oxide-supported tantalum complexes formed from pentabenzyltantalum. Heating of metal oxide-supported tantalum complexes formed from pentabenzyltantalum in flowing hydrogen or alkanes, or mixtures thereof, at a temperature approximately between 100° C. and 350° C. enables the formation of metal oxide-supported clusters of tantalum. The average cluster nuclearity (i.e., the number of metal atoms in the cluster) can be controlled by heating metal oxide-supported tantalum complexes formed from pentabenzyltantalum in a temperature range between approximately 25° C. and 500° C. under hydrogen, alkanes, or mixtures thereof. The supported tantalum clusters may incorporate various groups bonded to them, such as hydrogen ligands or hydrocarbon ligands.

The material incorporating the tantalum clusters can be used as a catalyst for disproportionation of alkanes by contacting the metal oxide-supported tantalum clusters with alkanes at approximately 250° C. The catalyst can also be used for other conversions of alkanes, such as the reaction of methane with another alkane.

In one aspect, the present invention provides a method of forming supported Group 4, and/or 5, and/or 6 metal clusters, which may be used to catalyze alkane reactions. The method includes combining a solid support and a precursor compound of Group 4, 5, or 6 metals, or precursor compounds of group 4, and/or 5, and/or 6 metals, or a precursor compound of a combination of group 4, 5, and/or 6 metals, and combinations thereof, and optionally treating the combination to form the supported Group 4, and/or 5, and/or 6 clusters.

In another aspect, the present invention provides a process for catalyzing the conversion of alkanes. The process includes providing a material comprising a support and supported group 4, 5, and/or 6 metal clusters; and contacting the material with the alkanes.

In another aspect, the present invention provides a process for catalyzing the reaction of mixtures of alkanes. The process includes providing a material comprising a support and supported group 4, and/or 5, and/or 6 metal clusters, and using the material to catalyze the reaction of mixtures of alkanes.

In another aspect, the present invention provides for a process controlling the size of the supported Group 4, and/or 5, and/or 6 metal clusters, which may be used as a catalyst for alkane reactions.

For a further understanding of the nature and advantages of the invention, reference should be made to the following description taken in conjunction with the accompanying drawings.

### BRIEF DESCRIPTION OF THE DRAWINGS

FIG. 1 is a graph of test results showing the catalytic performance of a material incorporating supported tantalum clusters (approximated as supported tritantalum clusters) for the disproportionation of ethane.

FIG. 2 is a graph of test results showing the catalytic performance of the material incorporating supported tantalum clusters (approximated as supported tritantalum clusters) for the conversion of methane and butane reacting with each other.

FIG. 3 shows the k³-weighted Fourier transform of the EXAFS function (solid line) and the best fit parameters (dashed line) for the material incorporating the silica-supported clusters approximated as tritantalum clusters (k is the wave vector, a term used in X-ray absorption spectroscopy). EXAFS refers to extended X-ray absorption fine structure spectroscopy, one type of X-ray absorption spectroscopy.

FIG. 4 shows the k¹-weighted Fourier transform of the EXAFS function (solid line) and the best fit parameters (dashed line) for the material incorporating the silica-supported clusters approximated as tritantalum clusters.

FIG. 5 shows the k³-weighted Fourier transform of the EXAFS function (solid line) and the best fit parameters (dashed line) for the material incorporating silica-supported clusters larger on average than tritantalum clusters.

FIG. 6 shows the k¹-weighted Fourier transform of the EXAFS function (solid line) and the best fit parameters (dashed line) for the material incorporating silica-supported clusters larger on average than tritantalum clusters.

### DETAILED DESCRIPTION OF THE INVENTION

As set forth above, the embodiments of the present invention are directed towards a method of converting alkanes and the preparation and use of supported metal clusters whereby the metals are taken from group 4, and/or group 5, and/or group 6 of the Periodic Table of the Elements, with tantalum being one non-limiting example thereof. The metal clusters are supported on powder metal oxides, solid supports, or other supports such as zeolites or other molecular sieve or mesoporous materials and are active for the catalytic conversion of alkanes to produce alkanes which have molecular weights different from those of the reacting alkane or alkanes. The solid support can be silica, a metal oxide, a zeolite, a metal phosphate, or a material incorporating a metal and oxygen, and combinations thereof. The embodiments of the present invention stabilize metal atoms from the above-mentioned groups in the form of supported clusters. Another aspect of the present invention is directed towards a method for controlling the average number of metal atoms comprising each supported cluster, which, in addition to the formation of supported clusters, is also a significant improvement over the current state of the art.

As described above, one exemplary preparation of metal oxide-supported tantalum clusters, in accordance with the embodiments of the present invention, involves the following sequential steps:

1. A metal oxide is used as a support and optionally treated before the metal is supported thereon. In one embodiment, the metal oxide is treated in a manner that causes dehydroxylation, for example, by treatment under vacuum at approximately 500° C. for a duration of time. In one embodiment, the duration is about 16 hours.

2. A precursor compound (e.g., pentabenzyltantalum) is provided or synthesized by the method outlined by Groysman et al. (Organometallics, 22:3793 (2003)).

3. The precursor (e.g., pentabenzyltantalum) and the optionally dehydroxylated metal oxide support are slurried in an organic solvent (e.g., hexane). The solvent (e.g., hexane) is removed under vacuum after stirring the mixture overnight with the exclusion of air and moisture. The resulting mononuclear metal complex bonded to the metal oxide support is then treated to form metal oxide-supported metal clusters.

Additional and more detailed examples of the preparation of pentabenzyltantalum for use in the catalyst preparation; preparation of metal oxide-supported species formed from pentabenzyltantalum; and the preparation of metal oxide-supported tantalum clusters from the metal oxide-supported species formed from pentabenzyltantalum are provided below. In addition, results of tests of the catalytic activity of the material consisting of the metal oxide and metal oxide-supported tantalum clusters are provided below.

### Example

### Preparation of Pentabenzyltantalum for Use in Catalyst Preparation

Pentabenzyltantalum, for use in catalyst preparation, was synthesized by following the method of Groysman et al. (Organometallics, 22:3793 (2003)) in all respects except for the following:
the synthesis procedure was scaled up two- to four-fold
mixed hexanes were used instead of toluene
the liquid containing pentabenzyltantalum was removed from the mixture formed in the preparation
the liquid product containing pentabenzyltantalum was combined directly with the optionally partially dehydroxylated silica (already slurried in hexanes) when following method 2, below, for the preparation of silica-supported mononuclear tantalum complexes formed from pentabenzyltantalum.

The pentabenzyltantalum made by the above procedure was authenticated by comparison of its proton NMR spectrum with that reported by Groysman et al. in the publication cited above.

### Example

### Preparation of Silica-Supported Species Formed from Benzyltantalum

The silica-supported species formed from pentabenzyltantalum was prepared using either of the following two methods.

Method 1: Aerosil 200 (fumed silica supplied by Degussa) was partially dehydroxylated at 500° C. under vacuum for 15 hours. Red crystals of pentabenzyltantalum were slurried with partially dehydroxylated silica in a Schlenk flask using mixed hexanes with the exclusion of air and moisture. After stirring for 12 hours, the hexanes were removed by evacuation to give a white powder that has been characterized by EXAFS spectroscopy and infrared (IR) spectroscopy as silica-supported tantalum complexes formed from pentabenzyltantalum.

Method 2: Aerosil 200 (supplied by Degussa) was partially dehydroxylated at 500° C. under vacuum for 15 hours. An orange-red solution of pentabenzyltantalum in mixed hexanes was combined with partially dehydroxylated silica (already slurried in hexanes in a Schlenk flask) with the exclusion of air and moisture. After stirring for 12 hours, the hexanes were removed by evacuation to give a white powder that has been characterized by EXAFS spectroscopy and IR spectroscopy as silica-supported tantalum complexes formed from pentabenzyltantalum.

### Example

### Preparation of Silica-Supported Clusters Formed from Silica-Supported Tantalum Complexes Formed from Pentabenzyltantalum

The material containing silica-supported tantalum clusters formed from silica-supported tantalum complexes formed from pentabenzyltantalum was prepared by contacting alkanes, hydrogen, inert gases (herein defined as Group 18 elements or dinitrogen gas (N₂)) or mixtures thereof with silica-supported tantalum complexes at temperatures in the range of 100° C. to 500° C. as is described below.

Method 1: The material consisting of silica-supported tantalum complexes formed from pentabenzyltantalum was heated to temperatures in the range of 100° C. to 500° C. in the presence of flowing hydrogen at atmospheric pressure for 1 day to yield a brown powder that has been characterized by EXAFS spectroscopy, UV-visible (“UV-vis”) spectroscopy and IR spectroscopy as silica-supported tantalum clusters to which hydride ligands are bonded, as indicated by IR spectroscopy. Exposure of this sample to methane, ethane, or butane yields silica-supported clusters approximated as tritantalum clusters to which hydrocarbon ligands are bonded, as determined by EXAFS spectroscopy and IR spectroscopy.

Method 2: Silica-supported tantalum complexes formed from pentabenzyltantalum were heated to temperatures in the range of 100° C. to 500° C. in the presence of butane at atmospheric pressure for 1 day to give a brown powder that has been characterized by EXAFS spectroscopy, UV-visible “UV-vis” spectroscopy and IR spectroscopy as silica-supported tantalum clusters to which hydrocarbon ligands are bonded.

Method 3: Silica-supported tantalum complexes formed from pentabenzyltantalum were heated to temperatures in the range of 100° C. to 500° C. in the presence of helium at atmospheric pressure for 1 day to give a brown powder that has been characterized by EXAFS spectroscopy as silica-supported tantalum clusters.

Method 4: Silica-supported tantalum complexes formed from pentabenzyltantalum were heated to temperatures in the range of 100° C. to 500° C. in the presence of methane and butane at atmospheric pressure for 1 day to give a brown powder that has been characterized by EXAFS spectroscopy, UV-vis spectroscopy and IR spectroscopy as silica-supported tantalum clusters.

### Example

### Preparation of Silica-Supported Clusters Containing Various Numbers of Tantalum Atoms within the Cluster Formed from Silica-Supported Tantalum Complexes Formed from Pentabenzyltantalum

The material containing silica-supported clusters of various sizes formed from silica-supported tantalum complexes formed from pentabenzyltantalum was prepared by contacting alkanes, hydrogen, inert gases or mixtures thereof (herein defined as Group 18 elements of the Periodic Table of the Elements (referred to previously) or dinitrogen gas (N₂)) with silica-supported tantalum complexes at temperatures in the range of 100° C. to 500° C. as is described below.

Silica-supported clusters that are on average approximated as smaller than tritantalum clusters: Silica-supported tantalum complexes formed from pentabenzyltantalum were heated to temperatures in the range of 100° C. to 200° C. and preferably in the range of 125° C. to 175° C. in the presence of hydrogen at atmospheric pressure for 15 hours to give a brown powder that has been characterized as silica-supported clusters that are on average approximated as smaller than tritantalum clusters

Silica-supported clusters that are on average approximated as tritantalum clusters: Silica-supported tantalum complexes formed from pentabenzyltantalum were heated to temperatures in the range of 200° C. to 300° C. and preferably in the range of 225° C. to 275° C. in the presence of hydrogen at atmospheric pressure for 15 hours to give a brown powder that was characterized as silica-supported clusters that are on average approximated as tritantalum clusters. Silica-supported clusters that are on average approximated as tritantalum clusters were prepared by heating silica-supported tantalum complexes formed from pentabenzyltantalum to temperatures in the range of 200° C. to 300° C. and preferably in the range of 225° C. to 275° C. in the presence of methane and butane at atmospheric pressure for 15 hours to give a brown powder that has been characterized as silica-supported clusters that are on average approximated as tritantalum clusters.

Silica-supported clusters that are on average approximated as larger than tritantalum clusters: Silica-supported tantalum complexes formed from pentabenzyltantalum were heated to temperatures in the range of 300° C. to 400° C. and preferably in the range of 325° C. to 375° C. in the presence of hydrogen at atmospheric pressure for 15 hours to give a brown powder that has been characterized as silica-supported clusters that are on average approximated as larger than tritantalum clusters. The same may also be prepared by heating silica-supported tantalum complexes formed from pentabenzyltantalum to temperatures in the range of 300° C. to 400° C. and preferably in the range of 325° C. to 375° C. in the presence of methane and butane at atmospheric pressure for 15 hours to give a brown powder that has been characterized as silica-supported clusters that are on average approximated as larger than tritantalum clusters.

Silica-supported clusters that are on average approximated as much larger than tritantalum clusters: Silica-supported tantalum complexes formed from pentabenzyltantalum were heated to temperatures in the range of 400° C. to 500° C. and preferably in the range of 425° C. to 475° C. in the presence of hydrogen at atmospheric pressure for 15 hours to give a brown powder that has been characterized as silica-supported clusters that are on average approximated as much larger than tritantalum clusters. Silica-supported clusters that are on average approximated as much larger than tritantalum clusters may also be prepared by heating silica-supported tantalum complexes formed from pentabenzyltantalum to temperatures in the range of 400° C. to 500° C. and preferably in the range of 425° C. to 475° C. in the presence of methane and butane at atmospheric pressure for 15 hours to give a brown powder that has been characterized as silica-supported clusters that are on average approximated as much larger than tritantalum clusters.

As described above, the materials can be used as catalysts for the disproportionation of alkanes by contacting of the tantalum clusters supported on the metal oxide with alkanes at approximately 250° C., and as catalysts for the reaction of two different alkanes with each other to form alkanes with molecular weights different from those of the starting alkanes at approximately 250° C.

### EXAMPLES

### CATALYTIC ACTIVITY OF SILICA-SUPPORTED CLUSTERS APPROXIMATED AS TRITANTALUM clusters

### Example

### Disproportionation of Ethane

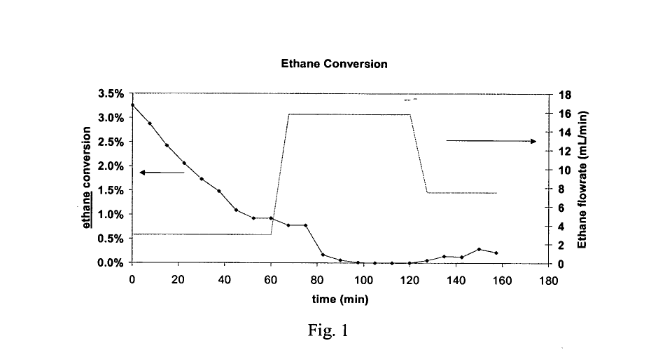

The material consisting of silica and silica-supported clusters approximated as tritantalum clusters was found to be catalytically active for the disproportionation of ethane to give propane and methane. A powder material consisting of silica and silica-supported clusters approximated as tritantalum clusters was brought into contact in a tubular flow reactor with flowing ethane at atmospheric pressure and a temperature of approximately 250° C. Conversion of ethane as a function of time onstream was determined quantitatively by gas chromatography, and the products of the conversion were identified qualitatively by gas chromatography. A blank reaction experiment was carried out with silica alone used instead of the powder material consisting of silica and silica-supported clusters approximated as tritantalum clusters, and no conversion of the ethane was observed. FIG. 1 is a graph of the test results of the catalytic activity of the material incorporating the clusters approximated as tritantalum clusters for the disproportionation of ethane. Ethane flow rate was varied to observe the effect of flow rate on conversion. The conversion increased as the flow rate of ethane in the flow reactor decreased at a given temperature, as expected for a catalytic reaction. These results demonstrate that silica alone is not catalytically active for this conversion under these conditions and further that the catalytic activity of the material is caused by the presence of the tantalum in the form of clusters in the material.

### Example

### Conversion of Methane and n-Butane to Propane and Ethane Using the Material Consisting of Silica and Silica-Supported Clusters Approximated as Tritantalum Clusters

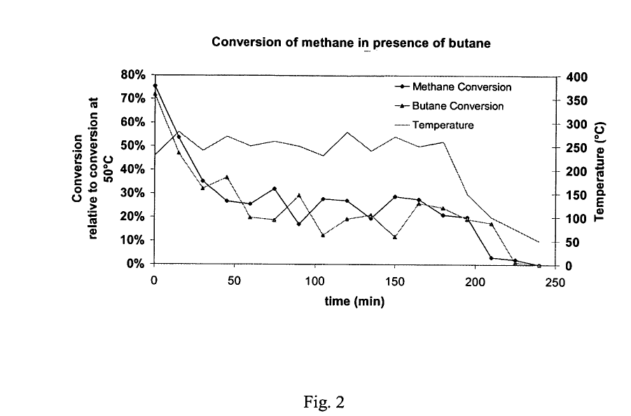

The material consisting of silica and silica-supported clusters approximated as tritantalum clusters was found to be catalytically active for the conversion of methane and n-butane to give propane and ethane. The material, in a tubular flow reactor, was contacted with a flowing mixture of approximately 1.6 wt % methane and 3 wt % n-butane with the balance being argon at approximately 250° C. and atmospheric pressure. The conversions of methane were determined quantitatively by gas chromatography, and the products were identified by gas chromatography. A blank reaction was carried out with silica alone used instead of the powder material consisting of silica and silica-supported clusters approximated as tritantalum clusters, and no conversion of the alkanes was observed, indicating that silica alone is not catalytically active for this conversion under these conditions and further that the catalytic activity of the material incorporating the tantalum clusters is caused by the presence of the tantalum. FIG. 2 is a graph of the test results indicating the catalytic activity of the material incorporating the clusters approximated as tritantalum clusters for the conversion of methane and butane. Reaction temperature was lowered near the end of the run time to allow observation of the effect of temperature on conversion; the qualitative effect of temperature is as expected for a chemical reaction.

### Example

### Conversion of Methane and n-Butane to Propane and Ethane Using the Material Consisting of Silica and Silica-Supported Clusters Approximated as Larger Than Tritantalum Clusters

The material consisting of silica and silica-supported clusters approximated as larger than tritantalum clusters was found to be catalytically active for the conversion of methane and n-butane to give propane and ethane. The material, in a tubular flow reactor, was contacted with a flowing mixture of approximately 1.6 wt % methane and 3 wt % n-butane with the balance being argon at approximately 250° C. and atmospheric pressure. The conversion of methane was determined quantitatively by gas chromatography, and the products were identified by gas chromatography. The catalytic activity of the material consisting of silica and silica-supported clusters approximated as larger than tritantalum clusters was less than that of the material consisting of silica and silica-supported clusters approximated as tritantalum clusters.

### Example

### Conversion of Methane and n-Butane to Propane and Ethane Using the Material Consisting of Silica and Silica-Supported Clusters Approximated as Much Larger Than Tritantalum Clusters

The material consisting of silica and silica-supported clusters approximated as much larger than tritantalum clusters is catalytically active for the conversion of methane and n-butane to give propane and ethane. The material, in a tubular flow reactor, was contacted with a flowing mixture of approximately 1.6 wt % methane and 3 wt % n-butane with the balance being argon at approximately 250° C. and atmospheric pressure. The conversion of methane was determined quantitatively by gas chromatography, and the products were identified by gas chromatography. The catalytic activity of the material consisting of silica and silica-supported clusters approximated as much larger than tritantalum clusters was less than that of the material consisting of silica and silica-supported clusters approximated as larger than tritantalum clusters and very much less than that of the material consisting of silica and silica-supported clusters approximated as tritantalum clusters.

### Example

### Structural Characterization of Silica-Supported Tantalum Clusters Approximated as Tritantalum Clusters

The data analysis procedure leading to the identification of the silica-supported clusters approximated as tritantalum clusters is described below.

The X-ray absorption measurements were performed at beamline 3-2 of the Stanford Synchrotron Radiation Laboratory (SSRL) of the Stanford Linear Accelerator Center, Stanford, Calif., and at beamline X-18B of the National Synchrotron Light Source (NSLS) at Brookhaven National Laboratory, Upton, N.Y. The storage ring electron energy was 3 GeV at SSRL and 2.6 GeV at NSLS; the ring current varied within the range of 50-100 mA at SSRL and 140-240 mA at NSLS. The handling of the catalytically active materials was performed with exclusion of air and moisture. Data were recorded at the Ta L_{III} edge in all measurements. Higher harmonics in the X-ray beam were minimized by detuning the monochromator by 20-25% at the Ta L_{III} edge. The data analysis was done using unfiltered data; the k range was 3.6-15.9 Å⁻¹ and the r range was 0.50-3.55 Å (r is the distance from the absorber atom, tantalum); k-weightings of 1, 2, and 3 were used in the Fourier transformations for the data representing the sample incorporating clusters approximated as tritantalum clusters, and weightings of 0 and 1 were used for the data representing the silica-supported tantalum complexes formed from pentabenzyltantalum prior to treatment to form tantalum clusters. A single multiple scattering reference was calculated and used in the analysis for Ta—Si contributions, because tantalum, oxygen, and silicon are nearly collinear in known structures (e.g., see Neithamer et al., J. Am. Chem. Soc., 111:9056 (1989)).

The statistically justified number of free parameters in the analysis was estimated on the basis of the Nyquist theorem to be 26 (e.g., see D. E. Sayers, B. A. Bunker, in the book edited by D. C. Koningsberger and R. Prins, X-Ray Absorption: Principles, Applications, Techniques of EXAFS, SEXAFS, and XANES, Wiley, New York, 1986, p. 211). Twenty four free parameters were used in the fit representing the supported clusters approximated as tritantalum clusters, and 16 free parameters were used in the fit representing the supported tantalum complex formed from pentabenzyltantalum prior to treatment to form tantalum clusters. Iterative fitting was carried out until agreement was obtained between the fits obtained at the various k-weightings. Small tantalum-oxygen contributions to the EXAFS were fitted by using the residual of the EXAFS after major contributions had been fitted.

The EXAFS spectra of silica-supported tantalum complexes formed from pentabenzyltantalum prior to treatment to form tantalum clusters (e.g., Table 1) demonstrate the presence of mononuclear site-isolated tantalum complexes as indicated by the lack of detectable Ta—Ta contributions. The EXAFS data indicate that each tantalum atom is bonded on average to four carbon atoms, at an average distance of 2.33 Å, typical of the Ta—C bonds in TaCp₂(CHPh)(CH₂Ph) (2.30 Å) (where Cp refers to cyclopentadienyl and Ph to phenyl). A Ta—O contribution was identified with a coordination number of approximately 2 (Table 1) at a distance of 1.90 Å, indicating bonding of tantalum to the silica surface; this distance is typical of Ta—O bonds, as in Ta(OC₆H₃-2,6-¹Pr₃)₃(H)₂(PMe₂Ph)₂ (Ta—O: 1.870, 1.907, and 1.897 Å) (where ⁱPr refers to isopropyl and Me to methyl). Consistent with this result, a Ta—Si contribution was also found. Thus, on the basis of the IR and EXAFS data, the supported species is approximated as a mononuclear benzyl tantalum complex bound to silica through two surface O atoms.

TABLE 1

| | Absorber- | | | | |
|---|---|---|---|---|---|
| | backscatterer | | | 10³ × Δσ² | |
| Sample | pair | N | R(Å) | (Å²) | ΔE₀ (eV) |
| Silica-supported | Ta—Ta | —^{a} | — | — | — |
| mononuclear tantalum | Ta—O | 2.6 | 1.90 | 1.52 | 6.0 |
| complex | Ta—C | 4.4 | 2.33 | 11.0 | −1.0 |
| | Ta—Si | 1.6 | 3.25 | 1.60 | −9.5 |
| | Ta—O_{long} | 1.9 | 2.95 | 0.01 | 6.7 |
| Silica-supported | Ta—Ta | 1.6 | 2.93 | 5.40 | −10.9 |
| mononuclear tantalum | Ta—O | 3.0 | 1.92 | 6.70 | 2.7 |
| complex treated in | Ta—O_{bridging} | 1.6 | 2.10 | 8.10 | 18.2 |
| H₂ at 423 K | Ta—Si | 5.3 | 3.27 | 5.70 | −8.3 |
| | Ta—C | 2.2 | 2.31 | 1.80 | 10.6 |
| | Ta—O_{long} | 2 | 2.92 | 14.1 | 4.6 |
| Silica-supported | Ta—Ta | 2.1 | 2.89 | 4.00 | 5.5 |
| mononuclear tantalum | Ta—O | 2.5 | 1.89 | 0.9 | 7.1 |
| complex treated in | Ta—O_{bridging} | 2.0 | 1.99 | 4.5 | 12.1 |
| H₂ at 523 K | Ta—Si | 3.8 | 3.25 | 2.0 | −16.0 |
| | Ta—C | 1.4 | 2.26 | 1.9 | 14.7 |
| | Ta—O_{long} | 2.6 | 2.77 | 4 | 3.5 |
| Silica-supported | Ta—Ta | 4.0 | 2.90 | 7.00 | 4.7 |
| mononuclear tantalum | Ta—O | 2.5 | 1.9 | 2.4 | 8.6 |
| complex treated in | Ta—O_{bridging} | 2.5 | 1.99 | 7.0 | 12.1 |
| H₂ at 623° C. | Ta—Si | 3.4 | 3.25 | 8.0 | −18.9 |
| | Ta—C | 4.0 | 2.31 | 13.0 | 18.8 |
| | Ta—O_{long} | 3.0 | 2.76 | 2.0 | 0.2 |
| Silica-supported | Ta—Ta | 6.0 | 2.91 | 6.60 | 14.0 |
| mononuclear tantalum | Ta—O | 3.3 | 1.91 | 0.2 | 5.2 |
| complex treated in | Ta—O_{bridging} | 1.8 | 2.00 | 2.8 | 7.0 |
| H₂ at 723° C. | Ta—Si | 3.3 | 3.23 | 0.3 | −16.0 |
| | Ta—C | 2.5 | 2.24 | 0.0 | 12.5 |
| | Ta—O_{long} | 7.0 | 2.69 | 6.5 | −12.5 |
| Silica-supported | Ta—Ta | 2.0 | 3.04 | 6.20 | 10.0 |
| mononuclear tantalum | Ta—O | 3.5 | 1.89 | 0.1 | 11.4 |
| complex treated in | Ta—O_{bridging} | 2.2 | 2.00 | 0.2 | 2.7 |
| H₂ at 523° C. | Ta—Si | 2.8 | 3.4 | 2.2 | −1.9 |
| after methane | Ta—C | 1.8 | 2.25 | 2.9 | 10.0 |
| conversion reaction at | Ta—O_{long} | 0.6 | 2.63 | 0.0 | −0.7 |
| 523 K | Ta—Ta | 4.1 | 3.03 | 9.50 | 6.0 |
| Silica-supported | Ta—O | 2.0 | 1.87 | 6.2 | 5.9 |
| mononuclear tantalum | Ta—O_{bridging} | 2.0 | 1.97 | 1.7 | 7.8 |
| complex treated in | Ta—Si | 3.7 | 3.39 | 1.7 | −7.2 |
| H₂ at 623° C. | Ta—C | 4.2 | 2.38 | 22.8 | 19.0 |
| after methane | Ta—O_{long} | 0.8 | 2.85 | 0.0 | −15.4 |
| conversion reaction | | | | | |
| at 523 K | | | | | |

Table 1. EXAFS parameters characterizing the sample made from chemisorption of Ta(CH₂Ph)₅ on partially dehydroxylated SiO₂, the same sample following treatment under flowing hydrogen at 150° C., 250° C., 350° C., 450° C. and samples treated in hydrogen at 250° C. and 350° C. after methane conversion reactions and the used catalyst after use in methane conversion reaction at 250° C. Notation: N=coordination number; R=distance between absorber and backscatterer atoms; Δσ²=Debye-Waller factor; ΔEₒ=inner potential correction. Estimated errors are approximately as follows: Ta—Ta: N±10%, R±0.02 Å, Δσ²±20%, ΔE₀±20%; Ta—C and Ta—O: N±30%, R±0.02 Å, Δσ²±25%, ΔEₒ±20%; Ta—Si: N±50%, R±0.03 Å, Δσ²±30%, ΔEₒ±20%. [a] Undetectable

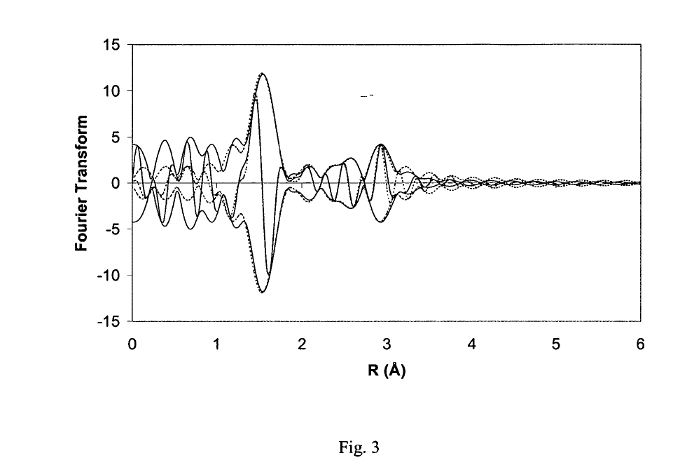

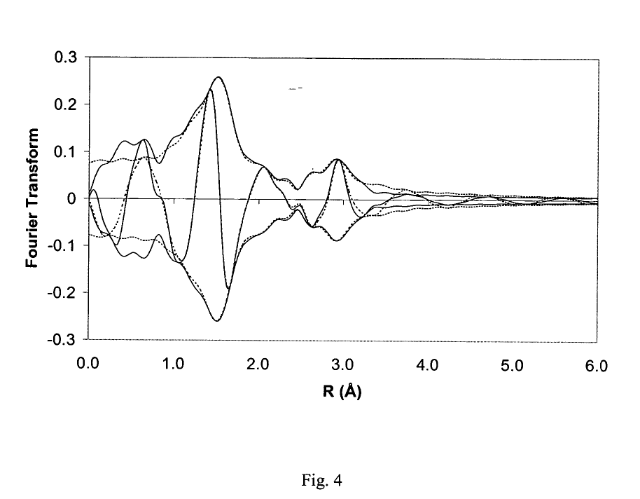

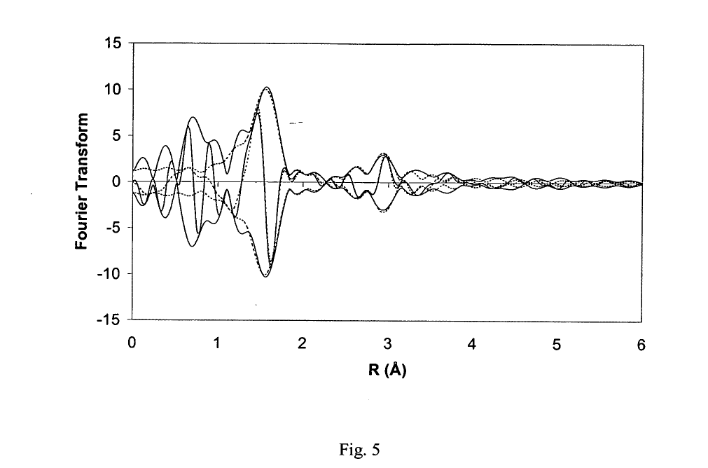

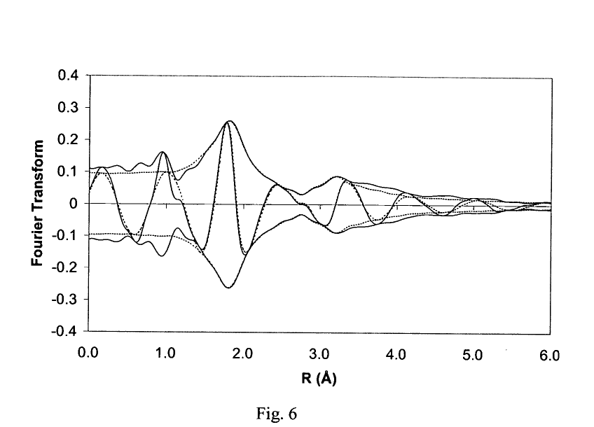

The material consisting of silica and silica-supported mononuclear tantalum complexes formed from pentabenzyltantalum was treated in flowing hydrogen for 1.5 days at approximately 250° C. at atmospheric pressure and characterized by EXAFS spectroscopy and IR spectroscopy (e.g., as shown in FIGS. 3-6). The IR data show that a new band grew in at 1860 cm⁻¹ along with small shoulders on both sides of it. These are attributed to Ta—H stretching frequencies. The IR spectra also demonstrate that hydrocarbon ligands had been lost from the pentabenzyltantalum precursor, as indicated by the lack of bands in the C—H and C—C stretching regions and the C—H bending region that are characteristic of pentabenzyltantalum.

The EXAFS data (FIGS. 3-6) characterizing the material after treatment in flowing hydrogen for 1 day at approximately 250° C. at atmospheric pressure show that tantalum clusters were formed on the support. Each tantalum atom was bound on average to approximately 2 tantalum atoms at a distance of 2.9 Å; thus, the supported species are approximated as tritantalum clusters. The EXAFS data also indicate bonding of each tantalum atom on average to approximately 4 oxygen atoms, two at a distance of 1.88 Å and two at a distance of 1.98 Å.

The EXAFS data characterizing the material after treatment in flowing hydrogen for 1.5 day at approximately 350° C. at atmospheric pressure show that tantalum clusters were formed on the support. Each tantalum atom was bound on average to approximately 4 tantalum atoms at a distance of approximately 2.9 Å; thus, the supported species are approximated as tantalum clusters larger on average than tritantalum clusters. These results demonstrate how it is possible to vary the average number of metal atoms per cluster on the support.

Additionally, UV-vis spectroscopy was also used to determine the presence of clusters, as is described below. UV-vis spectra characterizing the material consisting of silica and silica-supported mononuclear tantalum complexes formed from pentabenzyltantalum show no absorption bands in the 280 nm to 800 nm region of the spectra, consistent with the nearly white color of the material. The UV-vis spectra characterizing the material consisting of silica and silica-supported mononuclear tantalum complexes formed from pentabenzyltantalum after treatment in hydrogen for 1 day at 250° C. at atmospheric pressure is brown, and new absorption band maxima appear centered at 317 nm, with lesser maxima at 305 nm and 328 nm. The essential characteristics of the UV-vis spectra representing the material consisting of silica and silica-supported mononuclear tantalum complexes formed from pentabenzyltantalum after treatment in flowing hydrogen for 1 day at 250° C. at atmospheric pressure are retained for the material consisting of silica and silica-supported mononuclear tantalum complexes formed from pentabenzyltantalum after treatment in flowing hydrogen for 1.5 day at 350° C. and at 450° C. at atmospheric pressure. The presence of these absorption band maxima is indicative of the presence of tantalum-tantalum bonds, which is characteristic of tantalum clusters, as is recognized by those skilled in the art.

As will be understood by those skilled in the art, the present invention may be embodied in other specific forms without departing from the essential characteristics thereof. For example, steps may be combined or expanded during the synthesis of the metal oxide-supported metal clusters. These and other embodiments are intended to be included within the scope of the present invention, which is set forth in the following claims.

What is claimed is:

1. A composition of matter, comprising:
a solid support; and
a metal cluster selected from the group consisting of: metals of group 4, metals of group 5, metals of group 6, and combinations thereof, supported on the solid support,
wherein the composition of matter comprises bonding between the metals of the metal cluster and bonding between the metal cluster and the solid support.

2. The composition of matter of claim 1 wherein a metal atom of the metal cluster is bonded to at least one other metal atom of the metal cluster.

3. The composition of matter of claim 1 wherein a metal atom of the metal cluster is bonded to six or fewer metal atoms of the metal cluster.

4. The composition of matter of claim 1 wherein the solid support comprises a material selected from the group consisting of: a metal oxide, a zeolite, a metal phosphate, a material incorporating a metal and oxygen, and combinations thereof.

5. The composition of matter of claim 1 wherein the solid support comprises silica.

6. The composition of matter of claim 1 wherein the bonding between the metal cluster and the solid support comprises bonding between tantalum and silica.

7. The composition of matter of claim 6 wherein the bonding between the metal cluster and the silica comprises bonding between tantalum and oxygen on the silica surface.

8. The composition of matter of claim 1 wherein the bonding between the metals comprises bonding between tantalum and tantalum.

9. The composition of matter of claim 1 wherein a metal atom of the metal cluster is bonded to a hydrocarbon radical.

10. The composition of matter of claim 1 wherein a metal atom of the metal cluster is bonded to hydrogen.

11. A method for preparing solid-supported metal clusters, comprising:
forming a combination comprising a solid support and a compound selected from the group consisting of: a precursor compound comprising a metal from groups 4, 5, or 6, precursor compounds comprising metals from groups 4, 5, and 6, a precursor compound comprising a combination of group 4, 5, and 6 metals, and combinations thereof; and
optionally treating the combination to form the solid-supported-metal clusters.

12. The method of claim 11 wherein the precursor compound comprises a tantalum complex which lacks tantalum-tantalum bonds.

13. The method of claim 12 wherein the precursor compound comprises pentabenzyltantalum.

14. The method of claim 11 wherein the precursor compound comprises tantalum-tantalum bonds.

15. The method of claim 11 wherein the solid-supported metal clusters comprise tantalum-tantalum bonds.

16. The method of claim 11 wherein the solid-supported metal clusters are represented by any metal-metal coordination number determined by EXAFS spectroscopy that is greater than 0.

17. The method of claim 11 wherein the solid support comprises a material selected from the group consisting of a metal oxide, a zeolite, a metal phosphate, a material incorporating a metal and oxygen, and combinations thereof.

18. The method of claim 11 wherein said optionally treating comprises contacting the combination with a material selected from the group consisting of hydrogen, alkanes, and mixtures thereof at a temperature in a range between approximately 25° C. and 400° C.

19. The method of claim 18 wherein an increased temperature in the range effects an increase in the nuclearity of metal clusters.

20. The method of claim 11 wherein the solid support comprises silica.

21. The method of claim 11 wherein the solid-supported metal clusters comprise a metal-metal first-shell coordination number of approximately 2.

22. The method of claim 11 wherein the solid-supported metal clusters are characterized by a metal-metal first-shell coordination number in the range of 2 to 10.

23. The method of claim 11 wherein the precursor compound is dissolved in a solvent selected from the group consisting of: an alkane, an aromatic compound, and mixtures thereof.

24. The method of claim 23 wherein the combining comprises contacting the solid support with the solution comprising the precursor compound and the solvent.

25. A process for catalyzing the conversion of an alkane, comprising:
providing a material comprising a solid-supported metal cluster, wherein the metals of the metal cluster are selected from the group consisting of: group 4 metals, group 5 metals, group 6 metals, or combinations thereof; and
contacting the material with the alkane.

26. The process of claim 25 wherein the alkane excludes methane.

27. The process of claim 25 wherein the alkane is selected from the group consisting of: methane, propane, butane, pentane, hexane, and combinations thereof.

28. The process of claim 25 wherein the alkane contains n carbon atoms, where n is an integer greater than 1, and wherein the major products of the conversion incorporate n−k and n+k carbon atoms where k is a positive integer less than n.

29. The process of claim 25 comprising the conversion of alkanes wherein one of the alkanes incorporates m carbon atoms and the other alkane incorporates p carbon atoms, where p is greater than m, and where the major products of the conversion incorporate more than m carbon atoms.

30. A process for catalyzing the reaction of mixtures of alkanes, comprising:
providing a material comprising solid-supported metal clusters, wherein the metals of the metal clusters are selected from the group consisting of: group 4 metals, group 5 metals, group 6 metals, and combinations thereof; and
using said material to catalyze the reaction of mixtures of alkanes.

31. The process of claim 30 wherein one of the alkanes in the mixture of alkanes is methane.

32. The process of claim 30 wherein the mixture of alkanes comprises methane and another alkane containing u carbon atoms, where u is a positive integer greater than two, and major products of the conversion incorporate u−j carbon atoms, where j is a positive integer and is less than u.
